(19) United States
(12) Patent Application Publication
(10) Pub. No.: US 2001/0026219 A1
(43) Pub. Date: Oct. 4, 2001

(54) Battery having a lost article location module

(76) Inventor: Richard Sharpe, Woodridge, IL (US)

Correspondence Address: Lathrop & Gage LC, Suite 2800, 2345 Grand Boulevard, Kansas City, MO, 64108, US

(21) Appl. No.: 09/746,864

(22) Filed: Dec. 21, 2000

Related U.S. Application Data
(60) Provisional application No. 60/171,317, filed on Dec. 21, 1999.

(51) Int. Cl. G08B 13/14

(52) U.S. Cl. 340/571; 340/572.1; 340/572.8

(57) ABSTRACT

The present invention is directed to a power source for use in electronic articles to assist in the location of misplaced articles, and to a method for enabling a battery-operated electronic apparatus to recognize a desired actuation sound used by a lost article detector unit in deciding whether to activate a locating signal. The power source includes a power cell for supplying electrical energy to the electronic article, and a lost article detector module mounted to the power cell. The lost article detector module includes an input transducer that generates an internal signal in response to an audible sound and a locator signal generator that generates a locator signal in response to detection by the detector module of a desired actuating frequency of the audible sound.

### FIELD OF THE INVENTION

This invention relates to devices that are attachable to misplaceable objects and emit a signal locating the objects upon receipt of an audible actuation signal, and more specifically, to a battery mountable in an electronic apparatus and emitting a signal for locating the electronic apparatus upon receipt of an audible actuation signal.

### BACKGROUND OF THE INVENTION

Small electronic objects such as remote entry devices, and remote control units for TVS and VCRs are readily misplaced. It is known in the art to incorporate into such objects a detector unit that can emit an audible beeping signal when a definitive pattern of human-generated audible whistles, hand claps, or the like is heard. The recognizable patterns of human-generated sounds, hand claps for example, are termed desired actuation sounds. Examples of such detector units include U.S. Patent Nos.

Typically the detector unit includes a microphone, waveform shapers, electronic timers, a beeping sound generator, and a loudspeaker. The microphone is responsive to audible sound. The waveform shapers attempt to discriminate between waveforms resulting from desired actuation sounds, and waveforms from all other sounds. Ideally, the detector unit provides a beeping signal into the loudspeaker only when the desired searcher-generated actuation sounds are detected. The loudspeaker beeping is a locating signal that enables a user to locate the objects attached to the detector unit from the beeping sound.

Unfortunately, prior art detector units are only provided on select electronic apparatus or may be coupled by a cord or key ring to the electronic apparatus. It is cumbersome to add another item to empower the apparatus with this locator function and furthermore, some items, such as remote control units may not be retrofit by using a cord or a key ring.

Thus, there is a need for a detector unit that is easily mountable in current electronic apparatus and further that do not increase the bulk of the detector unit. Further, there is a need for such a detector unit that may be implemented in new, less expensive electronic apparatus. Also it is desirable to incorporate such a detector unit into a readily replaceable part of such electronic apparatus.

The present invention provides such a detector unit, and a method of retrofitting current electronic apparatus with a detection functionality.

### SUMMARY OF THE PRESENT INVENTION

Accordingly, an object of the present invention is to provide a battery with a detector unit. Another object of the present invention is the ability to retrofit current portable electronic apparatus with the ability to emit a location signal upon receipt of an auditory signal.

These objects are attained by the present invention that provides a power source for use in electronic articles and for assisting in the location of misplaced articles. The power source comprises at least one power cell for supplying electrical energy to the electronic article, and a lost article detector module mounted to the power cell. The lost article detector module includes an input transducer that generates an internal signal in response to an audible sound and a locator signal generator that generates a locator signal in response to detection by the detector module of a desired actuating frequency of said audible sound.

In another aspect of the present invention, these objects are attained by a method for enabling a battery-operated electronic apparatus to recognize a desired actuation sound used by a lost article detector unit in deciding whether to activate a locating signal. The method comprises the steps of supplying a battery-operated electronic apparatus, supplying a battery equipped with a lost article detector module mounted to the battery, and installing the battery into the battery-operated electronic device. The lost article detector module includes an input transducer that generates an internal signal in response to an audible sound and a locator signal generator that generates a locator signal in response to detection by said detector module of a desired actuating frequency of said audible sound.

Other features and advantages of the invention will appear from the following description in which the preferred embodiments have been set forth in detail, in conjunction with the accompanying drawings.

### BRIEF DESCRIPTION OF THE DRAWINGS

FIG. 1 is a side elevational view of a battery of the present invention having a lost article detector module mounted therein.

FIG. 2 is a block diagram of the circuit of the lost article detector module of the present invention.

### DETAILED DESCRIPTION OF THE PREFERRED EMBODIMENT

Broadly, the present invention comprises a battery that incorporates an electronic article-locating unit that is responsive to the user upon the creation of a sequence of sounds having a frequency(ies) and amplitude(s) falling within preselected ranges. The detection of a sound within the preselected sound range causes the unit to switch into an audible mode allowing the user to determine its location.

The battery of the present invention is mountable to any electronic object that is powered by a battery to provide a current to this object and further empower the object with the article-location functionality. Examples are numerous of possible items and include remote entry devices, remote control devices, and children's electronic toys. Because of the nature of the present invention, it can be made part of commonly misplaced electronic objects or items whose location can be determined by the user after he or she creates a correct sound frequency.

The electronic unit of the present invention runs continuously until the battery capacity is fully used. Continuous operation is possible due to the very low power consumption of the unit in its quiescent mode. By being on continuously, the unit is able to detect a correct sound sequence at any time. Upon detection of a correct sound frequency, the present invention switches to its audible mode to generate and emit audible sounds allowing the user to determine its location. The very low power consumption results from the method of operation of the circuitry of the present invention. Typical power consumption in the quiescent mode is eight to twenty microamps, allowing continuous operation to occur for months using standard batteries. Intermittent operation would obviously further conserve power.

The correct frequency sound for activating the unit is selected so that it can be readily created by the user (with no training) and yet be sufficiently different from the sounds normally encountered in the environment so as to prevent false triggering. The sounds need to have frequency components which fall within a preselected frequency spectrum. A preferred correct sound for properly activating the unit of the present invention comprises a whistle in the frequency range of 1.6 to 2.2 Khz and have an amplitude in the moderately loud range. Hereafter, for convenience, the present invention will be described as being activated by a whistle, although it will be understood that any suitable loud noise in a predetermined frequency range may be employed.

The objective is to allow the unit in its listening mode to continuously monitor ambient sounds and to switch into its audible mode only when it detects the correct sound frequency produced by the user. Upon detection of this correct sound, the unit will then emit audible tones which will allow the user to determine its location.

Since the correct sound frequency generated by the user is received in the battery, any battery-operated electronic device may be retrofitted with the ability for determining the location of the missing article.

In operation, in the listening mode, the input/output transducer of the present invention produces an output signal in accordance with any received sound that falls within the frequency response of the transducer. This output signal is amplified and then amplitude and/or frequency compared in a detection circuit.

Upon detection of the correct sound frequency (i.e., a whistle), the detection circuitry causes the unit to switch to its audible mode. A pulse generator produces pulses when the received sounds are within the predetermined frequency spectrum of the transducer and exceed a predetermined amplitude level. The pulses provided by the pulse generator are supplied to a driver and the unit emits a continuous tone or a sequence of intermittent tones for a predetermined time period, which allows the user to locate the unit and, hence, the missing article in which the battery is located.

Certain non-user generated ambient or environmental sounds and noise bursts must be taken into account in order to obtain long-term battery life and to avoid the nuisance of the unit misfiring. A filter is provided to block ambient and environmental sounds that do not meet the preselected criteria.

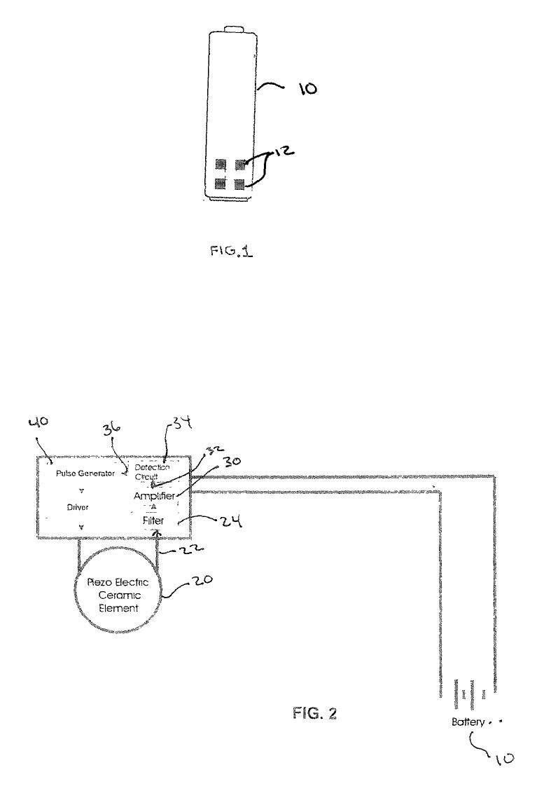

Turning now to the figures and particularly to FIG. 1, an electronic article locating battery of the present invention is generally indicated at 10. The battery includes operates as a standard battery and, in addition, includes a lost article detector module having an article-location circuit mounted in the battery for sensing a predetermined frequency and providing an audible response thereto and apertures 12 for allowing passage of pose the preselected frequency locating sound and the audible response.

It will be understood by those skilled in the art that many different circuits may be used to provide the article-location response to a preselected circuit, and many different circuits may be used for different circumstances. In FIG. 2 there is illustrated a block diagram of a preferred circuit of the present invention. The circuit includes a transducer 20, which provides a signal on a line 22 in accordance with sound received by the transducer. In addition, transducer 20 will emit an audible tone of a preselected frequency in accordance with the signal received from line 22. Thus, transducer 20 operates in two modes: listening (receiving), and audible (transmitting). A preferred form for transducer 20 is a piezoelectric ceramic sensor. Such a piezoelectric sensor exhibits a pure capacitance as its impedance is of a very high value. The sensor is highly sensitive and can sense the preselected frequency at a distance of approximately 3 meters.

When a piezoelectric sensor is used for transducer 20, it not only provides a signal on line 22 in accordance with the received sound, but also acts as a filter since its frequency response is non-linear. This allows a piezoelectric sensor to be chosen which provides an output for the frequency component(s) of sounds within its passband and filters out or blocks all other frequency components. A typical frequency response spectrum is 1000 to 2500 Hertz. This filtering response improves the ability of the unit of the present invention to detect a “correct” sound sequence.

Transducer 20 is a sensitive device. For example, if it is dropped, it will generate a high energy and voltage spike. In order to prevent damage to the remainder of the circuitry, transducer 20 has back-to-back diodes (not shown) connected to it to prevent damage when the unit is operating in either its listening or audible mode. This will also eliminate static electricity damage to the remainder of the circuit.

Output line 22 is connected to an input of filter 24 to further block and filter out ambient frequency components other than a preselected frequency range. The output of filter 24 is connected to an amplifier 30. Amplifier 30 amplifies the low level received signal (typically six to ten millivolts) at its input and supplies an amplified signal on a line 32. A preferred form for amplifier 30 is an operational amplifier.

The output of amplifier 30 is coupled to a detection circuit 34. Detection circuit 34 may be of many well known types, but serves to amplitude compare the received sound at a specific frequency to a preselected frequency range and amplitude. Detection circuit 34 is coupled to pulse generator 40. If the incoming sound falls within the preselected frequency and is of a sufficient amplitude, detection circuit 34 provides a signal along line 36 to pulse generator 40. Broadly, pulse generator provides an output signal in a high state when the input signal on line 32 fits within the preselected frequency. An envelope shaper (not shown) may be connected to the output of the pulse generator.

The audible tone(s) emitted during the audible mode is generated as follows. The high output signal of the pulse generator is provided to a driver 50 which produces a regulated output to the transducer 20 to generate an audio signal of preselected frequency. Any type of audio signal can be produced. A preferred form for the audio signal is a serial square wave having a very sharp rise time and fall time. This produces an intermittent and pulsing audible sound. The sharp rise and fall times of the pulses enhance the audible tone to the user. The audible alarm produces is preferably approximately 85 db mode at a distance of 10 centimeters.

A low battery signal (not shown) is also part of the present invention. When the capacity of battery is below some predetermined level, the above described circuit may be adapted as is well known in the art to emit a signal to inform the user of this condition. Alternatively a LED signal may be connected to the battery to indicate a low battery condition.

The article-location circuit drains only 15 microamps at standby and approximately 800 microamps at sound output. Thus, the article-location functionality of the battery only effects the capacity of the battery minimally.

In summary, the unit of the present invention is on continuously. Upon detection of a correct sound frequency, or alternatively, a sequence of sounds, it switches to the audible mode and produces an audible tone(s), allowing the user to determine. The unit of the present invention is extremely small in size and can be fabricated using automated techniques since the circuit that is employed does not require the selection of specific components to make up for process parameters. The present invention thus is a great improvement over the prior art due to its small size, reliable operation, long operating life, and low manufacturing cost.

Obviously, numerous modifications and variations of the present invention are possible in light of the above teachings. It is therefore to be understood that within the scope of the appended claims, the invention may be practiced otherwise than as specifically described herein.

What is claimed is:

1. A power source for use in electronic articles and for assisting in the location of misplaced articles, the power source comprising
at least one power cell for supplying electrical energy to the electronic article, and
a lost article detector module mounted to the power cell, the lost article detector module comprising an input transducer that generates an internal signal in response to an audible sound and a locator signal generator that generates a locator signal in response to detection by said detector module of a desired actuating frequency of said audible sound.

2. The power source of claim 2, wherein the power cell is a battery and the battery further includes openings for receiving and emitting sounds.

3. The power source of claim 1, wherein the input transducer is a piezo-electric element and wherein the piezo-electric element likewise generates the audible locator signal.

4. The power source of claim 3, wherein the audible sound for generating the locator signal is in the frequency range of 1.6 kilohertz to 2.2 kilohertz.

5. The power source of claim 4 wherein the audible sound for generating the locator signal is a whistle.

6. The power source of claim 1 wherein the lost article detector module further includes a filter to block ambient noise from generating an audible locator signal.

7. The power source of claim 1 wherein the lost article detector module further generates a signal to indicate a low capacity condition for the battery is a LED display.

8. The power source of claim 7 wherein the signal indicating a low capacity condition for the battery is an auditory signal.

9. A method for enabling a battery-operated electronic apparatus to recognize a desired actuation sound used by a lost article detector unit in deciding whether to activate a locating signal, the method comprises the steps of,
supplying a battery-operated electronic apparatus,
supplying a battery equipped with a lost article detector module mounted to the battery, the lost article detector module comprising an input transducer that generates an internal signal in response to an audible sound and a locator signal generator that generates a locator signal in response to detection by said detector module of a desired actuating frequency of said audible sound, and
installing the battery into the battery-operated electronic device.
